(19) United States
(12) Patent Application Publication
(10) Pub. No.: US 2007/0050170 A1
(43) Pub. Date: Mar. 1, 2007

(54) Device characteristics measuring system

(75) Inventors: Michitoshi Noguchi, Tokyo (JP); Satoshi Habu, Tokyo (JP)

Correspondence Address: Paul D. Greeley;Ohlandt, Greeley, Ruggiero & Perle, L.L.P., 10th Floor, One Landmark Square, Stamford, CT, 06901-2682, US

(73) Assignee: Agilent Technologies, Inc.

(21) Appl. No.: 11/509,297

(22) Filed: Aug. 24, 2006

(30) Foreign Application Priority Data
Aug. 31, 2005 (JP) 2005-252294

(51) Int. Cl. G01D 1/00

(52) U.S. Cl. 702/127

(57) ABSTRACT

In measuring characteristics of a device such as PRAM, inputted pulse signal is made blunt and a voltage applied to the device and a current flowing through the device cannot be precisely measured. To solve these problems, the present invention provides a resistor for making a voltage drop of a signal outputted from the pulse generator. The active differential probe outputs a signal corresponding to a potential difference between the both ends of the resistor. The signal is inputted to an oscilloscope.

### BACKGROUND OF THE INVENTION

1. Field of the Invention

The present invention relates to a measuring apparatus for evaluating the characteristics of a device such as PRAM (Phase-change Random Access Memory) that is also called an Ovonic Unified Memory.

2. Description of the Related Art

PRAM is a memory capable of storing information by making use of a change of the state from amorphous to crystalline structure of substance such as chalgonide alloy of which electric resistance is changed by crystalline state of the substance. PRAM is characterized in that data of PRAM are held even if power supplied to PRAM is switched off and in that a large amount of data can be stored in the PRAM. A phase change of PRAM is carried out by a heater provided for each memory cell.

In measuring characteristics of PRAM, it is required that a voltage and a current of pulse signals applied to the device are accurately measured.

A voltage and a current applied to PRAM device under test can be measured by an oscilloscope directly from the device (for example, see prior art document 1, FIG.4, identified below).

FIG. 17 is a schematic diagram to be inputted to a circuit simulator in a case where an oscilloscope is directly connected to the device as explained above. In the figure, reference character 200b denotes an equivalent circuit of the device under test, 20b denotes an equivalent circuit of a pulse generator that generates pulse signals, 500 denotes an equivalent circuit of an oscilloscope for measuring a voltage, 510 denotes an equivalent circuit of an oscilloscope for observing a current, 520 denotes a shunt resistor for observing a current by the oscilloscope 510, 100b denotes a virtual ampere meter provided on the circuit simulator, 70 denotes a coaxial cable connecting the output terminal of the pulse generator 20b with the input of the voltage observing oscilloscope 500, 73 denotes a coaxial cable connecting the input of voltage observing oscilloscope 500 with the device 200b, 74 denotes a coaxial cable connecting virtual ampere meter 100b with one end of the resistor 520.

FIG. 18 is graphs indicating values of voltages of the respective portions of the circuit of the FIG. 17 in a case where this circuit is inputted into the circuit simulator. In FIG. 18, reference character “a” denotes a graph of a voltage observed by the voltage observing oscilloscope 500, “b” denotes a graph of a voltage between the both ends of the device 200b. As shown in the figure, the graph “a” is quite different from the graph “b,”therefore, it is understood that the voltage observed by the voltage observing oscilloscope 500 does not accurately reflect the voltage actually applied between the device 200b.

FIG. 19 is graphs indicating values of currents of the respective portions of the circuit of the FIG. 17 in a case where this circuit is inputted into the circuit simulator. In FIG. 19, reference “a” denotes a graph of a current observed by the current observing oscilloscope 510, “b” denotes a current flowing through virtual ampere meter 100b. As shown in the figure, the graph “a” is quite different from the graph “b” similarly to the case of voltage, and therefore the current observed by the current observing oscilloscope 510 does not accurately reflect the current actually flowing through the device 200b.

Further, a voltage and a current applied to the device under test can be measured with a probe (for example, see non-patent document 2, FIG. 3, identified below).

FIG. 20 is a circuit diagram to be inputted to the circuit simulator in a case where a voltage and a current applied to the device under test with a probe. The same reference character is attached to the same part as is indicated in the FIG. 17 and the duplicate explanation is omitted. In the FIG. 20, reference character 600 denotes an equivalent circuit of a probe, 700 denotes a resistor for measuring a current, 75 denotes a coaxial cable connecting one end of the resistor 700 with the output of the pulse generator 20b, 76 denotes a coaxial cable connecting the other end of the resistor 700 with the virtual ampere meter 100b.

FIG. 21 is graphs indicating voltages of the respective portions in a case where the circuit of FIG. 20 is inputted into the circuit simulator. In FIG. 21, reference character “a” denotes a graph of simulated voltage that is observed by the voltage observing oscilloscope. In the equivalent circuit of FIG. 20, an equivalent circuit of oscilloscope does not appear because signals are terminated by probe 600. The reference character “b” denotes a graph of a simulated voltage applied between the both ends of the device 200b. As shown in this figure, these graphs “a” and “b” almost overlap with each other. Namely, a result of the simulation shows that a voltage applied between the both ends of the device 200b can be measured. However, the leading edge of the voltage wave lags, and the waveform of the voltage becomes quite blunt. It is important to provide pulses having a rectangular shape with PRAM and it is unfavorable for the waveform to become blunt.

FIG. 22 is a graph indicating a current flowing through the virtual ampere meter 100b in a case where the circuit of FIG. 20 is inputted into the circuit simulator. As shown in FIG. 22, the leading edge of the current wave lags and the waveform of the current becomes blunt similarly to the case of the voltage waveform.

The current waveform cannot be observed directly. Considering that a pulse of 5 volts is applied to one end of the resistor 700, a height of the current pulse can be obtained by calculation. However, preciseness of the voltage value of the pulse generator 20b is not very high, therefore, it is difficult to obtain a height of the current pulse with high accuracy.

(1) Prior Art Document 1

“Low-Field Amorphous State Resistance and Threshold Voltage Drift in Chalcogenide Materials,” PIROVANO et al., IEEE Transactions on Electron Devices, Vol. 51 Issue 5 pp. 714-719, May 2004

(2) Prior Art Document 2

“Phase-change chalcogenide nonvolatile RAM completely based on CMOS technology,” Hwang, Y. N. et al., VLSI Technology, Systems, and Applications, 2003 International Symposium pp. 29-31, October 2003

### Summary of the Invention

As explained above, it is difficult to measure a voltage and a current applied to a device such as PRAM set on a prober. Further, there is a problem that the waveforms of voltage and current are different from those of the voltage and current outputted from a pulse generator. Furthermore, there is another problem that the waveforms become blunt.

Present invention was made in the above circumstances and the object of this invention is to provide a device measuring system that is capable of precisely measuring a voltage and a current actually applied to a device under test while the pulses inputted to the device are not blunt.

In order to obtain the object explained above, the present invention provides a device characteristics measuring system that measures the characteristics of a device under test, the system comprising: a pulse generator that generates pulses, a first probe for making an electric contact with the device, a resistor for measuring a current flowing through the device, a first cable for electronically connecting an output terminal of the first probe with one end of the resistor, a second cable for electronically connecting an output terminal of the pulse generator with the other end of the resistor, a second probe for making electrical contacts with both ends of the resistor and for outputting a signal corresponding to a potential difference between the both ends of the resistor, and a first signal waveform observing unit for observing a waveform of a signal outputted from the second probe. The first signal waveform observing unit corresponds to a specific channel of an oscilloscope. However it is not limited to an oscilloscope and other apparatus can be used if waveform of a signal can be observed with the apparatus. A signal corresponding to a potential difference between the both ends of the resistor is inputted to the first signal waveform observing unit by the second probe. Therefore, a low measuring range can be used where waveform can be observed with high resolution. Further, a current measuring resistor having a low resistance can be used because a large voltage drop is not necessary. Therefore, blunt leading edge of waveform can be suppressed in minimum.

A device characteristics measuring system of the present invention further comprises a third probe for making an electrical contact with the one end of the resistor, and a second signal waveform observing unit for observing a waveform of a signal outputted from the third probe. The second signal waveform observing unit corresponds to a specific channel of an oscilloscope. The first signal waveform observing unit and the second signal waveform observing unit can be structured in different channels of a single oscilloscope or in different oscilloscopes.

A device characteristics measuring system of the present invention further comprises a capacitor that is connected in parallel to the resistor for improving frequency characteristics. With this capacitor, the impedance in high frequency becomes low, which improves blunt leading edge of the waveform. Further, it is possible to precisely observing waveforms of a voltage applied to the device and a current flowing through the device by adjusting capacitance of the capacitor such that a waveform of a current flowing through the device is approximately identical to a waveform observed by the first signal waveform observing unit.

The present invention provides a device characteristics measuring system that measures the characteristics of a device under test, the system comprising: a pulse generator that generates pulses, a first probe for making an electrical contact with the device, a series combined resistor including a first resistor and a second resistor that is connected in series to the first resistor, a first cable for electrically connecting an output terminal of the first probe with one end of the series combined resistor, a second cable for electrically connecting an output terminal of the pulse generator with the other end of the series combined resistor, a second probe for making electrical contacts with both ends of the series combined resistor and for outputting a signal corresponding to a potential difference of the both ends of the series combined resistor, a first signal waveform observing unit for observing a waveform of a signal outputted from the second probe, a first capacitor connected in parallel to the series combined resistor for improving frequency characteristics, and a second capacitor electrically connected to the other end of the series combined resistor and a series connection point of the first resistor and the second resistor. Namely, the signal paths are made. One of the paths is a path that passes through the first capacitor. The other one is a path that passes through the second capacitor. Therefore, frequency characteristics of the signal transmission line can be corrected by setting capacitance values of the first and second capacitors and resistance values of the first and second resistors appropriately.

A device characteristics measuring system of the present invention further comprises: a third probe for making an electrical contact with the other end of the series combined resistor, and a second signal waveform observing unit for observing a waveform of a signal outputted from the third probe.

The device is made on a semiconductor wafer and the first probe is provided in a semiconductor prober.

The second probe and the third probe can be of an active type and an input impedance of the probes is higher than an output impedance of the probes. The first and second cables can be of a coaxial type.

Therefore, a device characteristics measuring system of the present invention is advantageous when a very short period of pulse signal is applied to a device such as a phase change memory.

These and other objects, features and advantages of the present invention will become more apparent in light of the following detailed description of a best mode embodiment thereof, as illustrated in the accompanying drawings.

### BRIEF DESCRIPTION OF DRAWINGS

FIG. 1 is a schematic diagram showing a structure of a device characteristics measuring system of an embodiment of the present invention.

FIG. 2 is an equivalent circuit of the circuit of FIG. 1 on which a circuit simulator works.

FIG. 3 is graphs indicating waveforms of voltages of respective portion in a case where simulation is carried out with the equivalent circuit of FIG. 2.

FIG. 4 is graphs showing currents of the respective portion in a case where simulation is carried out by using an equivalent circuit of FIG. 2.

FIG. 5 is a schematic diagram of device measuring system of another embodiment of the present invention.

FIG. 6 is an equivalent circuit of the device characteristics measuring system of FIG. 5.

FIG. 7 is graphs of voltages of the respective portions in a case where simulation is carried out by using the equivalent circuit of the FIG. 6.

FIG. 8 is graphs showing current wave shapes of the respective portions in a case where simulation is carried out by using an equivalent circuit of FIG. 6.

FIG. 9 is graphs of simulated voltages in a case where the capacitance of the capacitor is changed.

FIG. 10 is graphs of simulated measured currents in a case where the capacitance of the capacitor is changed.

FIG. 11 is a table showing the optimum values of the capacitance of the capacitor related to resistance values and the length of the cable.

FIG. 12 is a schematic diagram of the device measuring system of yet another embodiment of the present invention.

FIG. 13 is an equivalent circuit of the device characteristics measuring system indicated by FIG. 12.

FIG. 14 is graphs showing voltages of the respective portion in a case where simulation is carried out with the equivalent circuit of FIG. 13.

FIG. 15 is graphs of currents of the respective portions in a case where the simulation is carried out with the equivalent circuit of FIG. 13.

FIG. 16 is an equivalent circuit showing in what situation the embodiment of FIG. 12 is used.

FIG. 17 is a schematic diagram to be used for a circuit simulator in a case where an oscilloscope is directly connected to the device.

FIG. 18 is graphs indicating simulated values of voltages of the respective portion of the circuit of the FIG. 17.

FIG. 19 is graphs indicating simulated values of currents of the respective portions of the circuit of the FIG. 17.

FIG. 20 is an equivalent circuit to be used for the circuit simulator in a case where a voltage and a current applied to the device under test are measured with a probe.

FIG. 21 is graphs indicating simulated values of voltages of the respective portions of the circuit of the FIG. 20.

FIG. 22 is a graph indicating simulated values of a current flowing through the virtual ampere meter for the respective in the circuit of the FIG. 20.

### DESCRIPTION OF PREFERRED EBODIMENTS

Next, with reference to the accompanying drawings, the present invention will be explained in detail.

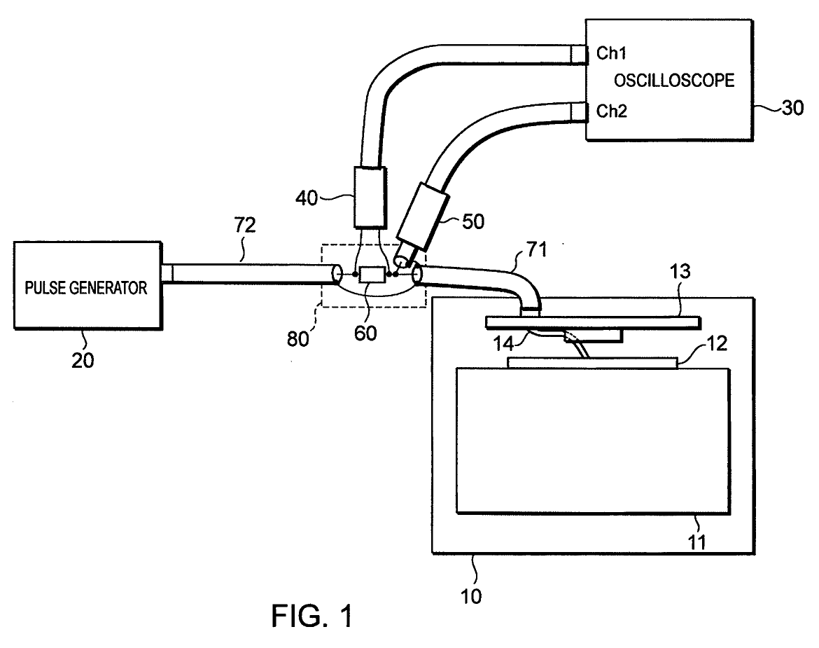

FIG. 1 is a schematic diagram showing a structure of a device characteristics measuring system of an embodiment of the present invention. In the figure, reference character 10 denotes a wafer prober for making an electrical contact with a device such as PRAM on semiconductor wafer, 20 denotes a pulse generator that outputs pulses having a constant voltage, 30 denotes an oscilloscope for measuring voltage applied to the device and current flowing through the device, 40 denotes an active differential probe for measuring a current flowing through the device, 50 denotes an active probe for measuring voltage applied to the device, 60 denotes a shunt resistor of 100 Ω for causing voltage drop in order to measure a current flowing through the device, 71 denotes a coaxial cable of 10 cm for connecting wafer prober 10 with one end of the shunt resistor 60, 72 denotes a coaxial cable of 200 cm for connecting the other end of the shunt resistor 60 with the output of the pulse generator 20.

The wafer prober 10 includes chuck 11 that mounts semiconductor wafer 12 and is movable for locating of probing, RF (Radio Frequency) probe 14 and probe card 13 for fixing RF probe 14 thereto. The chuck 11 is moved so that tips of the RF probe 14 are capable of making electrical contacts with terminals of device under test on semiconductor wafer 12.

Pulse generator 20 outputs pulses with 5 volts, pulse width being 20 nanoseconds, a rising time of leading edge of the pulses being 2 nanoseconds. An output signal from the active differential probe 40 is inputted to the channel one of the oscilloscope 30 and an output signal from the active probe 50 is inputted to the channel two of the oscilloscope 30.

The two input terminals of the active differential probe 40 are electrically connected to the both ends of the shunt resistor 60 so that the active differential probe 40 can output a signal corresponding to the voltage difference between the both ends. The active probe 40 amplifies an input signal and outputs amplified input signal. The impedance of the input side of the active differential probe 40 is higher than that of the output side of the active differential probe 40. The active probe 50 is electrically connected to a connecting point between the shunt resistor 60 and the coaxial cable 71. The active probe 50 amplifies an inputted signal and outputs the amplified inputted signal. The impedance of the input side of the active probe 50 is higher than that of the output side of the active probe 50. Further, the probes 40, 50 are terminated therein so that the circuit of the oscilloscope 30 does not affect the total equivalent circuit and does-not appear in the FIG. 1.

Moreover, the left end portion of the coaxial cable 71, the right end portion of the coaxial cable 72, the shunt resistor 60, a cable from the input of the active differential probe 40, a cable from the input of the active probe 50 are fixed to the circuit board 80 and electric wiring is made on the circuit board 80.

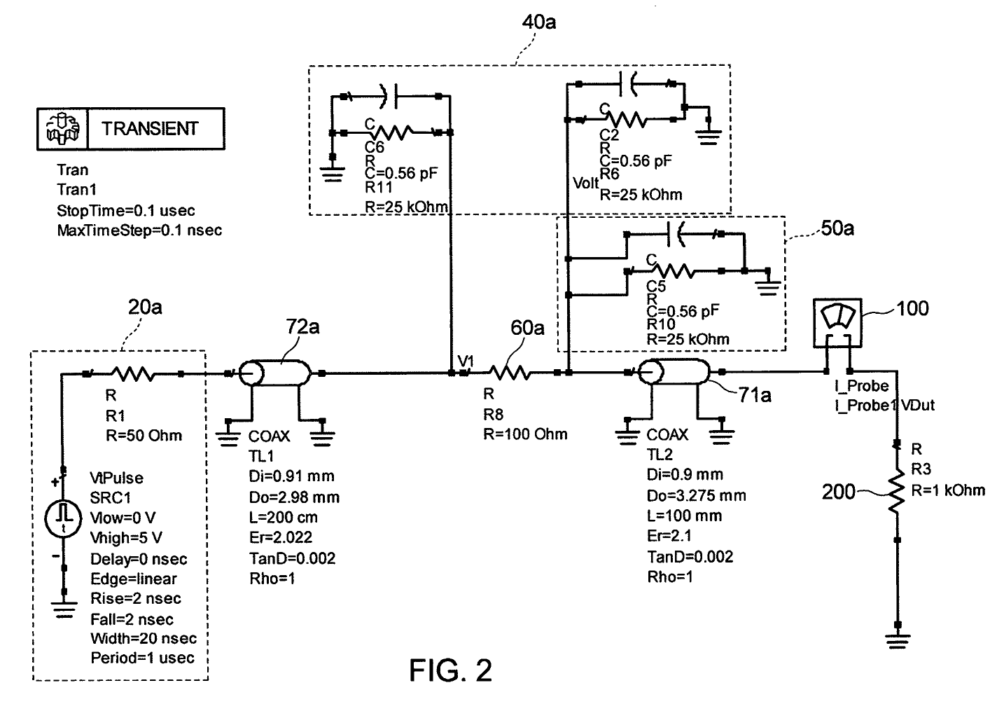

FIG. 2 is an equivalent circuit of the circuit of FIG. 1 on which a circuit simulator works.

In the figure, reference character 20a denotes an equivalent circuit of a pulse generator 20, which is represented by a series circuit of a pulse generating source and a resistor. The output impedance of the pulse generator 20 is 50 Ω. Reference character 40a denotes an equivalent circuit of the active differential probe 40. Each of the inputs is represented by a parallel circuit of a resistor of 25 kΩ and a capacitor of 0.56 pF, one end of which is grounded. Reference character 50a denotes an equivalent circuit of active probe 50, which is represented by a parallel circuit of a resistor of 25 kΩand a capacitor of 0.56 pF, which is inserted between an input terminal and ground.

Reference character 200 denotes an equivalent circuit of a device under test such as PRAM on the semiconductor wafer 12 , which is represented by a resistor of 1 kΩ. Reference character 100 denotes an virtual ampere meter on simulation, which is not provided in a real circuit but is used for measuring a current flowing through the device by simulation.

Reference characters 60a, 71a and 72a represent the shunt resistor 60, the coaxial cable 71 and the coaxial cable 72 on circuit simulator respectively.

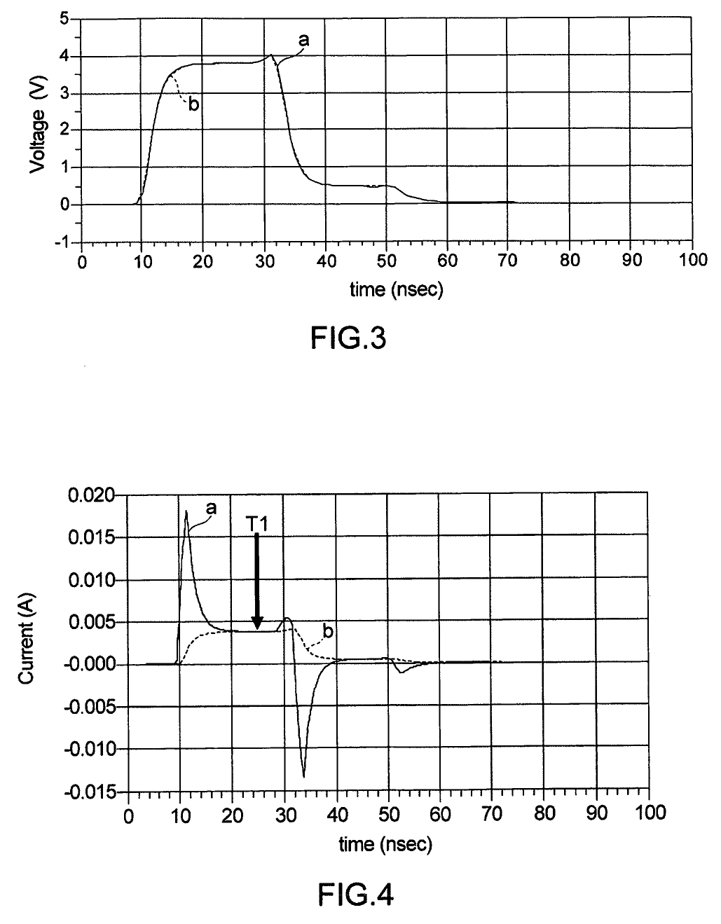

FIG. 3 is graphs indicating waveforms of voltages of respective portion in a case where simulation is carried out with the equivalent circuit of FIG. 2. In FIG. 3, reference character “a” denotes a graph showing a simulated voltage that would be inputted to the channel two of the oscilloscope 30 via the active probe 50 and reference character “b” denotes a graph showing a simulated voltage that would be applied to device under test. As shown in this figure, these graphs “a” and “b”almost overlaps with each other. This shows that a voltage can be measured accurately. Although the waveform of the voltage becomes a little blunt, the result of the simulation shows that the leading edge of the voltage rises abruptly and a waveform of the voltage resembles to that of pulses outputted from the pulse generator 20 and that a voltage applied to the device is close in shape to a pulse outputted from the pulse generator 20. The result also shows that a voltage applied to the device can be observed.

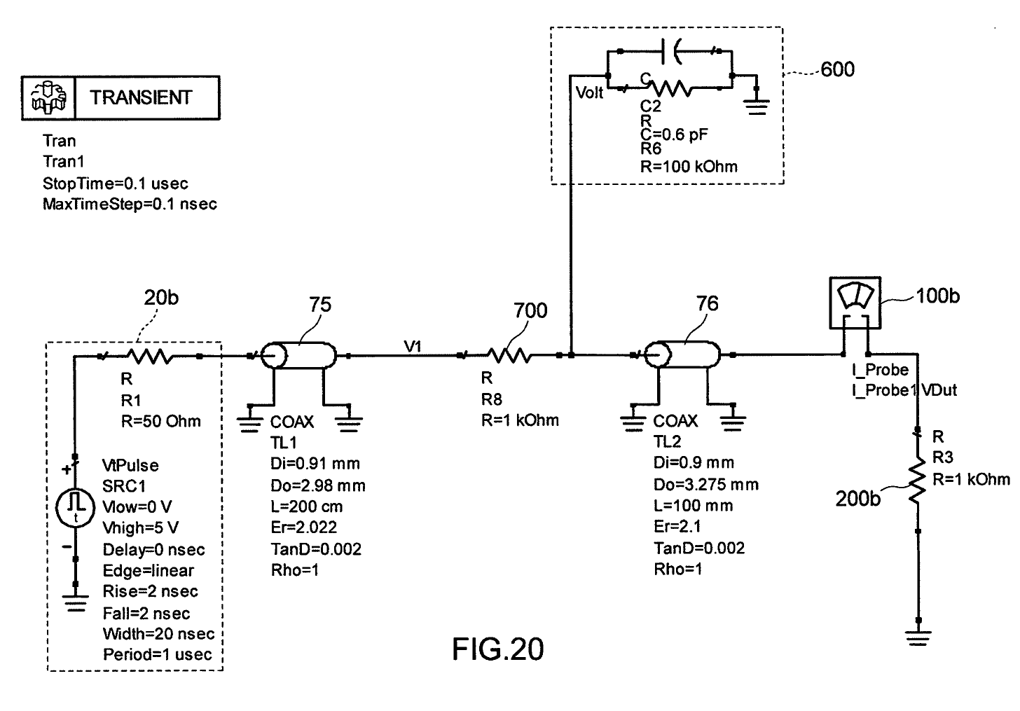

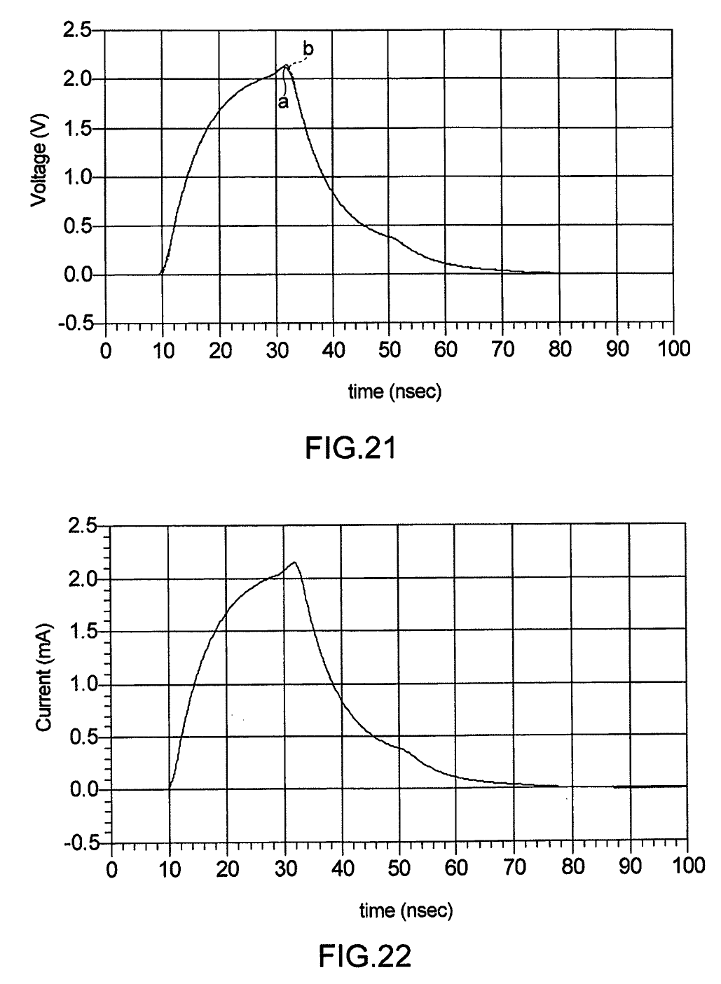

The reason why the graph is closer in shape to a pulse from the pulse generator 20 as compared with the case of FIGS. 20 and 21 is that the value of the shunt resistor 700 is 1 kΩ in the case of FIG. 20 whereas the value of the shunt resistor 60 is as low as 100 Ω in the case of FIG. 2 thereby the voltage applied to the device is less blunt in the case of FIG. 2. It is owing to the usage of a differential probe that the value of the shunt resistor 60 can be as low as 100 Ω. In the case of FIG. 20, it is necessary to measure the potential difference between the both ends of the resistor 700 when a current flowing through the device under test is desired to know. Assuming that a voltage from the pulse generator 20 is of 5 volts, it is necessary to obtain a relatively high voltage drop by the resistor 700 as compared with this value of 5 volts in relation to the resolution of the oscilloscope. On the contrary, in the case of FIG. 2, the shunt resistor 60 of as low as 100 Ω can be used because the active differential probe 40 outputs a signal corresponding to the potential difference between the both ends of the shunt resistor 60 thereby the oscilloscope 30 can be set to a low measuring range in which the high resolution can be obtained.

FIG. 4 is graphs showing currents of the respective portion in a case where simulation is carried out by using an equivalent circuit of FIG. 2. In FIG. 4, reference character “a” denotes a graph showing a simulated current flowing through the device under test with the active differential probe 40 and the oscilloscope 30 channel one of which is connected to the output of the differential probe 40, “b” denotes a current flowing through the virtual ampere meter 100, i.e., a graph of a simulated current flowing through the device under test. As shown in FIG. 4, although the graph “a” is much different from the graph “b” as waveforms, at a point where a certain time period elapses from a leading edge of a pulse and a current is in a steady-state, i.e., around the timing T1 of the FIG. 4, the values of currents in the graphs “a”and “b” are almost the same. Therefore, if a current is measured by the oscilloscope 30 when a certain period of time elapses from a leading edge of a pulse and a current is in a steady state, the value of a current that is the same as the wave height of a current pulse of graph “b”can be precisely obtained. Further, the overshoot and the undershoot of the graph “a” are based on the same time constant and are symmetric with respect to up and down directions. Therefore, a desired current waveform or a current value can also be obtained by correcting waveform with the overshoot and undershoot.

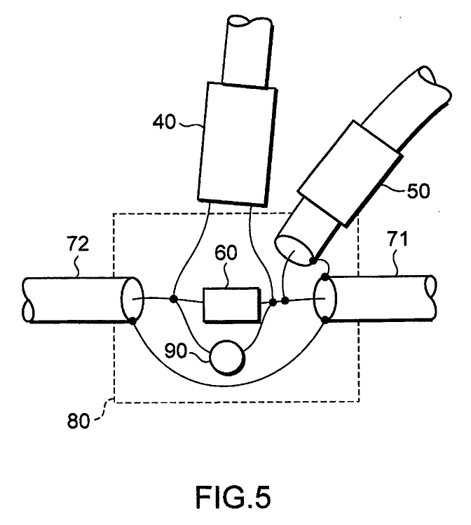

FIG. 5 is a schematic diagram of device measuring system of another embodiment of the present invention. This figure enlarges the vicinity of the circuit board 80 of the FIG. 1 and the other portions are the same as those depicted in the FIG. 1. Further, the same reference character is attached to the same portion as that of FIG. 1 and duplicate explanation is omitted. In FIG. 5, reference character 90 denotes a capacitor of 118 pF that is connected to the shunt resistor 60 in parallel.

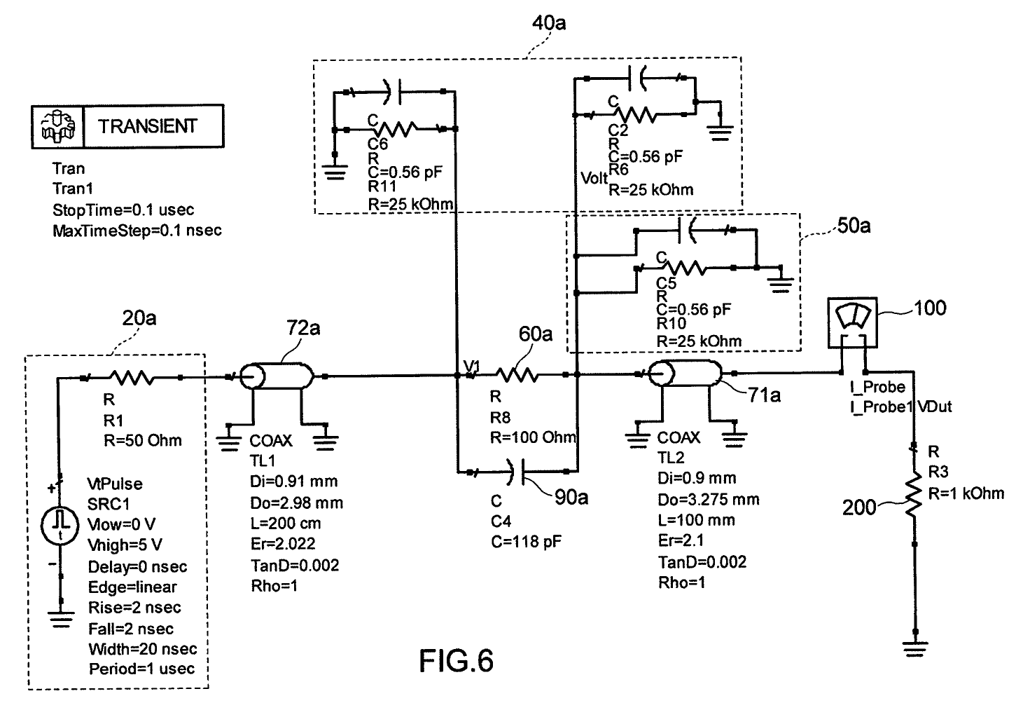

FIG. 6 is an equivalent circuit of the device characteristics measuring system of FIG. 5. The equivalent circuit is used for simulation by the circuit simulator. In FIG. 6, the same reference character is attached to the same portion as that of FIG. 2 and duplicate explanation is omitted.

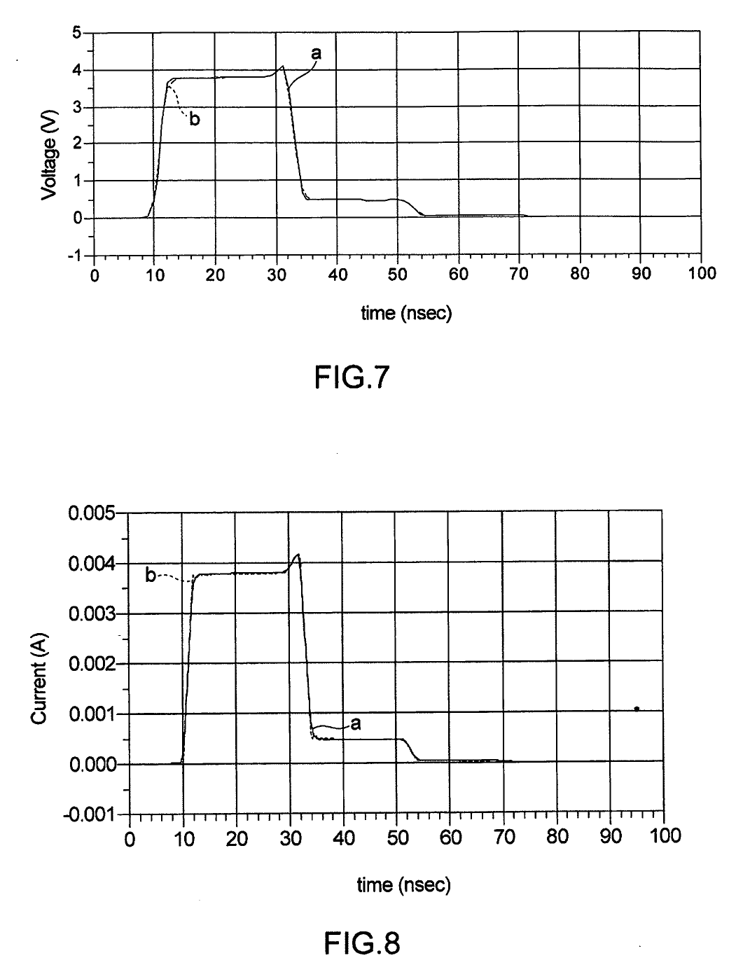

FIG. 7 is graphs of voltages of the respective portions in a case where simulation is carried out by using the equivalent circuit of the FIG. 6. In this figure, reference character “a” denotes a graph showing a simulated voltage that would be measured by the active probe 50 and oscilloscope 30 channel two of which is connected to the output of the active probe 50, “b”denotes a graph showing a simulated voltage that would be applied to the device under test. As shown in this figure, voltage waveforms almost overlap with each other, which indicates that the voltage can be measured precisely. The leading edge of the graph is more abrupt than that of FIG. 3. It is understood that the waveform on simulation is almost identical to the waveform of the pulse outputted from the pulse generator 20 because the rising time of the pulse outputted from the pulse generator 20 is approximately 2 nano seconds, which is almost the same time period indicated in FIG. 3.

FIG. 8 is graphs showing current wave shapes of the respective portions in a case where simulation is carried out by using an equivalent circuit of FIG. 6. In FIG. 8, reference character “a” denotes a graph showing a simulated current flowing through the device under test with the active differential probe 40 and the oscilloscope 30 the channel one of which is connected to the output of the active differential probe 40, “b” denotes a simulated current flowing through the virtual ampere meter 100, i.e., a simulated current that would flow through the device under test. As shown in this figure, the graph is almost identical to the shape of the pulse outputted from the pulse generator 20 in the same way for voltages shown in FIG. 7.

The reason why the characteristics are improved with the provision of the capacitor 90 is that high frequency components of the pulse easily passes between the both sides of the shunt resistor 60 by way of the capacitance 90.

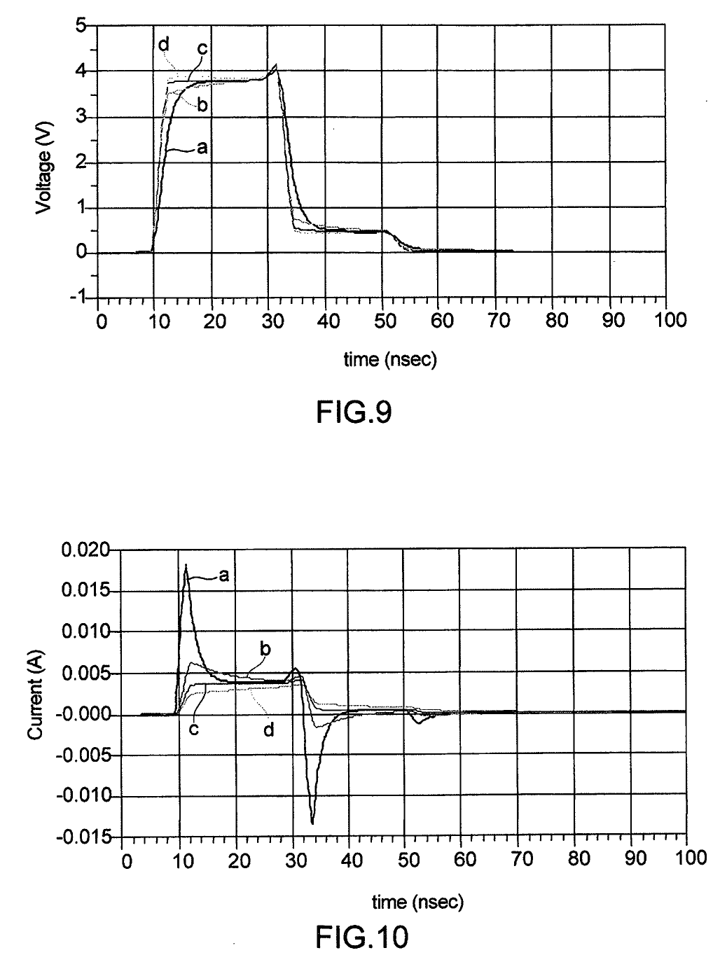

FIGS. 9 and 10 respectively are graphs of simulated measured voltages and graphs of simulated measured currents in a case where the capacitance of the capacitor 90 is changed from 118 pF. In these figures, reference characters “a”, “b”, “c” and “d” respectively denote graphs in cases where values of the capacitor 90 are 0 pF, 60 pF, 120 pF and 180 pF. It is understood from these graphs that the voltage wave shape is improved so that the leading edge of the wave shape becomes abrupt only if the capacitor 90 with some capacitance is attached to the shunt resistor 60. However, in order that the measured wave shape is almost identical to the real wave shape, it is necessary to adjust the capacitance of the capacitor 90. The appropriate capacitance of the capacitor 90 is determined based on a relative value of the impedance of the parallel circuit constituted of the shunt resistor 60 and capacitance 90, and the impedance of the serial circuit constituted of the coaxial cable 71 and the device under test. Accordingly, the capacitance of the capacitor 90 is determined based on the value of shunt resistor 60, the length of the coaxial cable 71, resistance of the device 200 and so on.

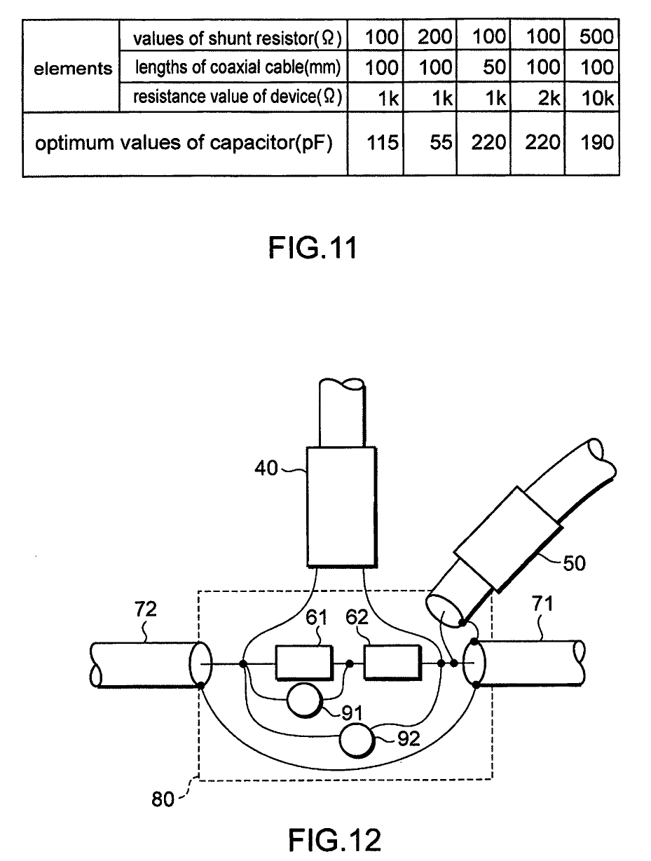

FIG. 11 is a table showing the optimum values of the capacitance of the capacitor 90 in a case where the value of the shunt resistor 60, the length of the coaxial cable 71 and the resistance value of the device 200 are changed. Strictly, the value of the capacitor 90 cannot be determined precisely, but the capacitance of capacitor 90 should be adjusted by a trimmer capacitor.

In FIG. 10, a desired current wave shape or current value can be obtained by correcting wave shape using the overshoot and undershoot in the same way as the case of FIG. 4 even if the capacitance of the capacitor 90 is not sufficiently adjusted such as graphs “a”, “b” and “d”. This is because the overshoot and undershoot take place based on the same time constant and thereby overshoot and undershoot are symmetric in the vertical direction.

FIG. 12 is a schematic diagram of the device measuring system of yet another embodiment of the present invention. This figure enlarges the vicinity of the circuit board 80 of the FIG. 1 and the other portions are the same as those depicted in the FIG. 1. Further, the same reference character is attached to the same portion as that of FIG. 1 and duplicate explanation is omitted. As shown in FIG. 12, the series circuit constituted of the shunt resistors 61 and 62 is connected between the coaxial cables 71 and 72. Further, the capacitor 91 is connected to the shunt resistor 61 in parallel. Furthermore, the capacitor 92 is connected in parallel to the series combined resistor constituted of the shunt resistors 61 and 62. The resistance values of the shunt resistors 61 and 62 are 150 Ω and 50 Ω respectively and capacitance values of the capacitors 91 and 92 are 40 pF and 35 pF respectively.

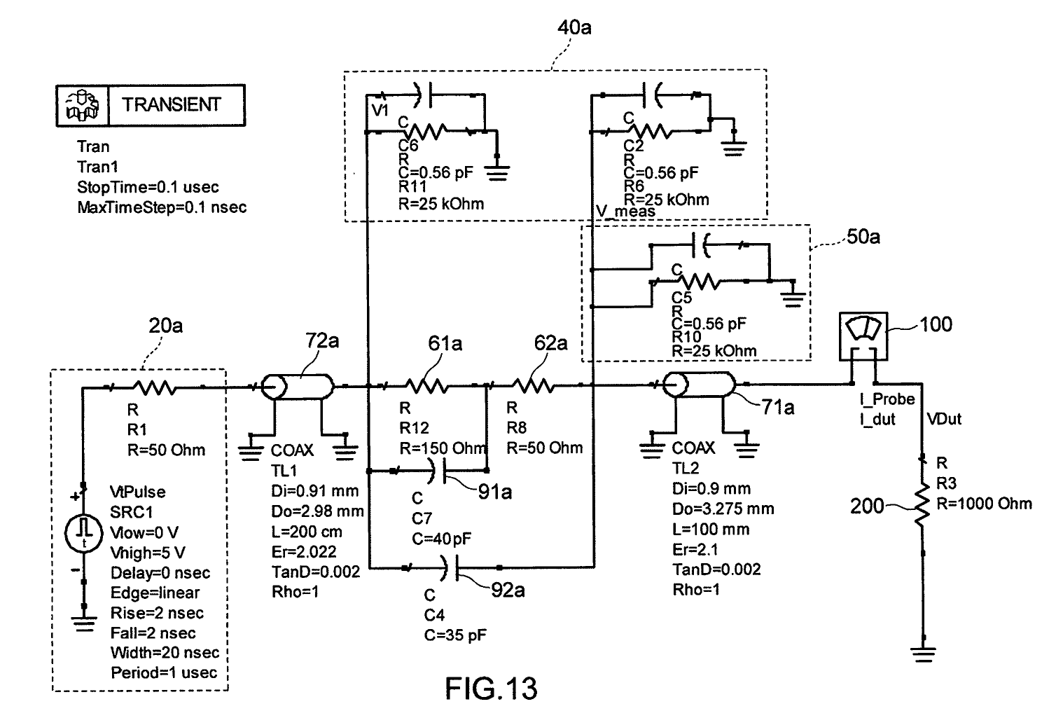

FIG. 13 is an equivalent circuit of the device characteristics measuring system indicated by FIG. 12 and this equivalent circuit is used for simulation by the circuit simulator. In FIG. 13, the same reference character is attached to the same portion as that of FIG. 2 and the duplicate explanation is omitted. In FIG. 13, reference characters 61a and 62a denote symbolic expressions of the shunt resistors 61 and 62 for the circuit simulator, and 91a and 92a denotes symbolic expressions of the capacitors 91 and 92 for the circuit simulator.

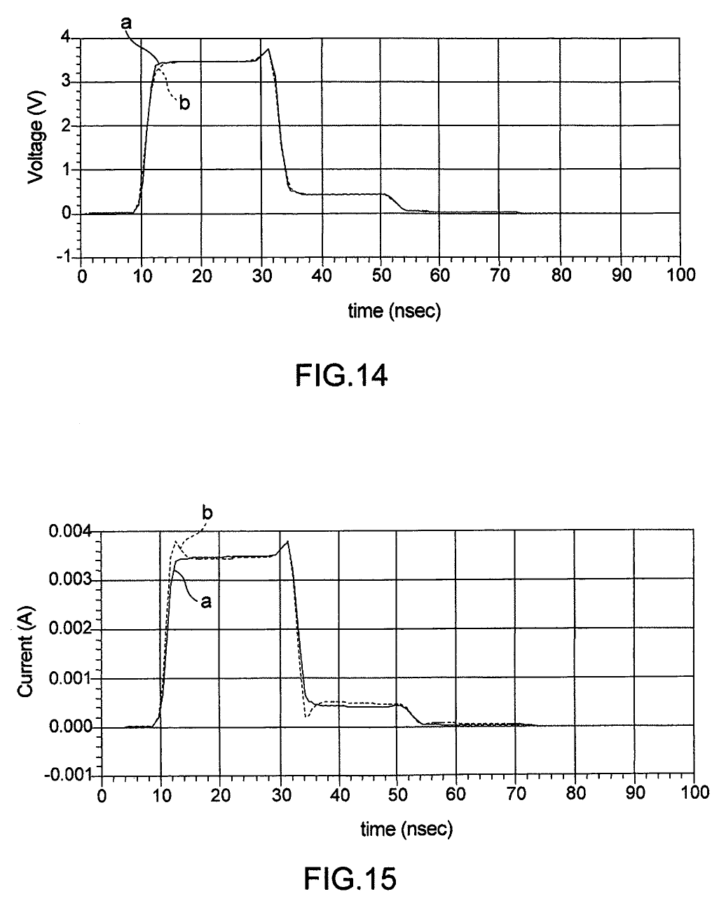

FIG. 14 is graphs showing voltages of the respective portion in a case where simulation is carried out with the equivalent circuit of FIG. 13. In FIG. 14, reference character “a” denotes a graph of a simulated voltage measured by the active probe 50 and the oscilloscope 30 channel two of which is connected to the output of the active probe 50, “b” denotes a graph of a simulated voltage applied to the device under test.

FIG. 15 is graphs of currents of the respective portions in a case where the simulation is carried out with the equivalent circuit of FIG. 13. In FIG. 15, reference character “a” denotes a simulated current measured by the active differential probe 40 and the oscilloscope 30 channel two of which is connected to the output of the active differential probe 40, “b” denotes a current flowing through the virtual ampere meter 100, i.e., a simulated current that would flow the device under test. The graph “b” of the FIG. 15 remarkably shows that an abrupt rise in current occurs at the leading edge portion. This change in wave shape indicates that frequency characteristics are corrected.

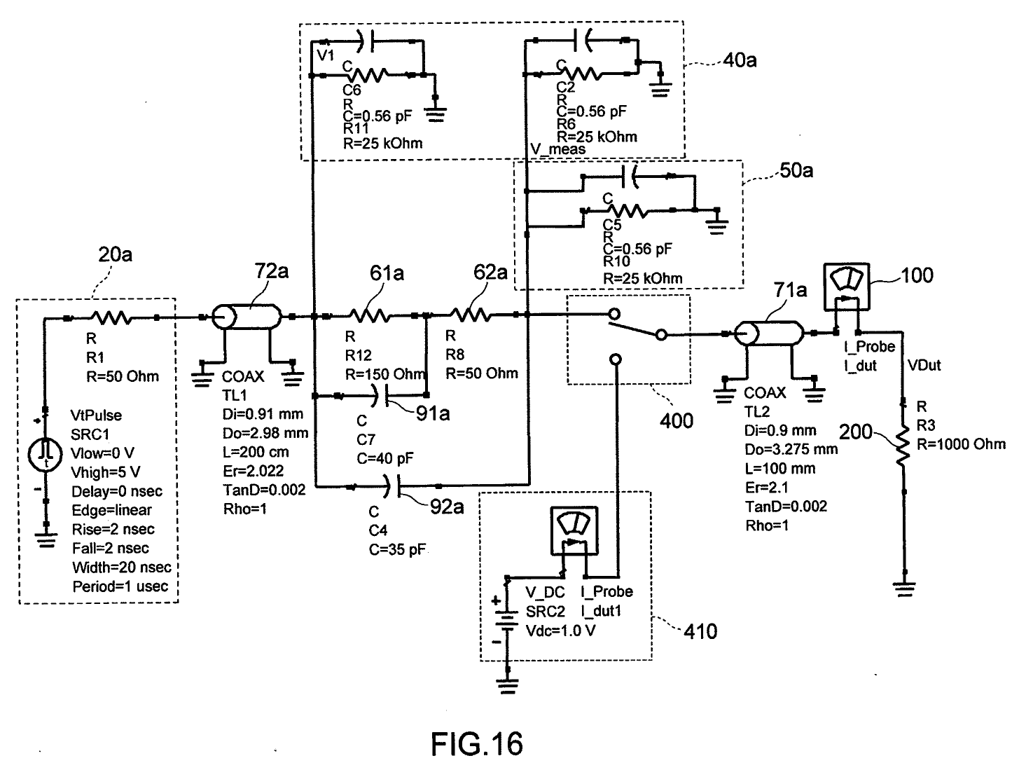

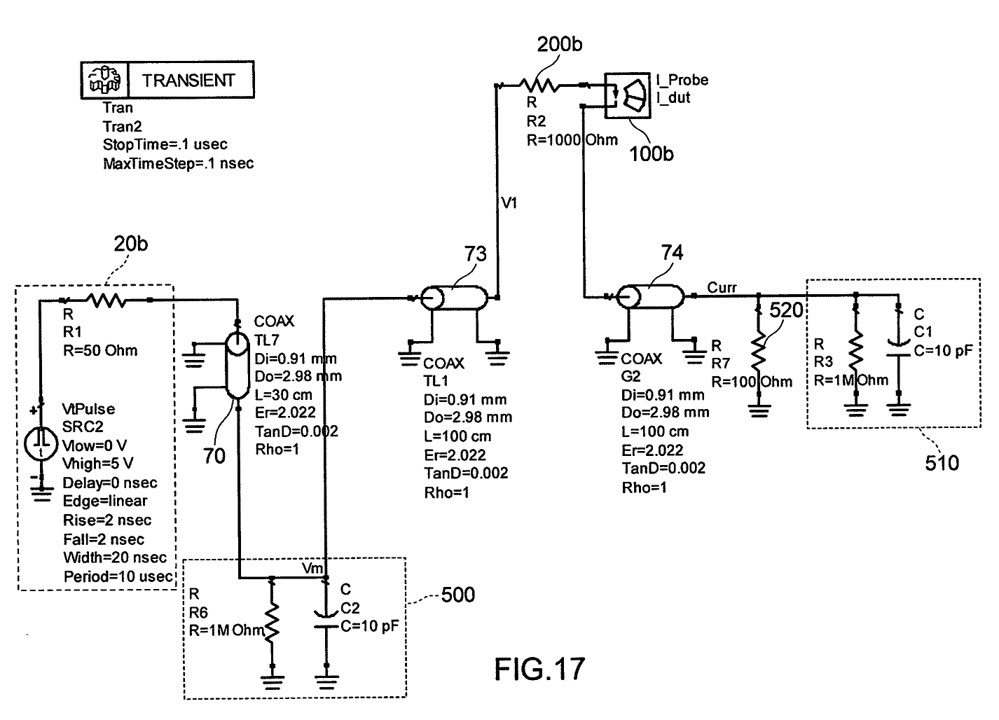

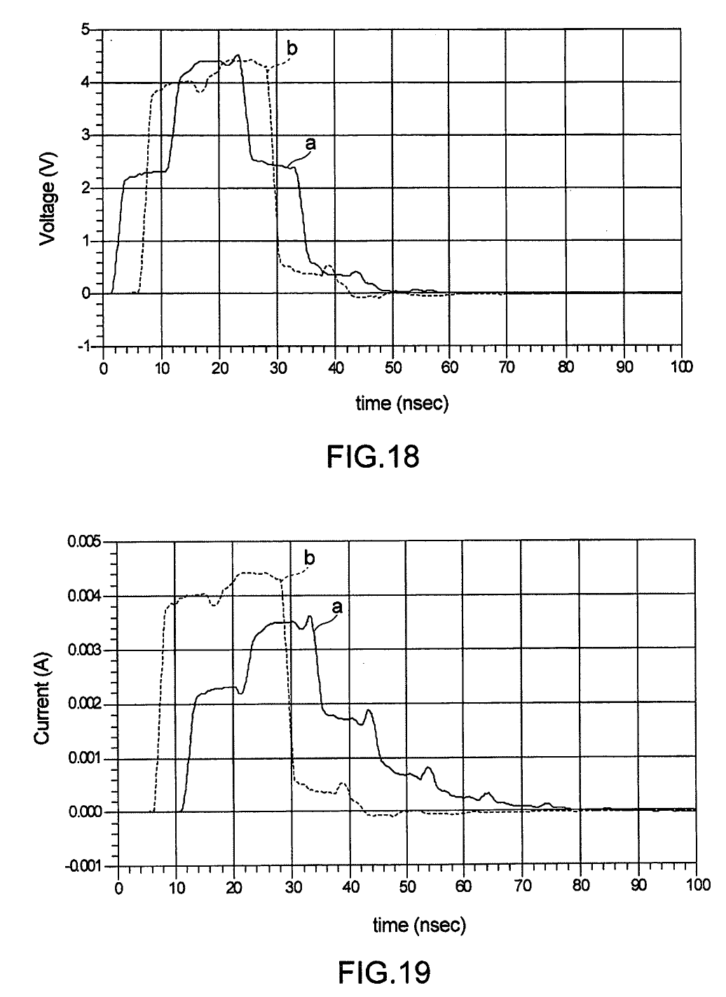

FIG. 16 is an equivalent circuit showing in what situation the embodiment of FIG. 12 is used. In FIG. 16, reference character 400 denotes a switch, 410 denotes an equivalent circuit of voltage-current characteristics measuring apparatus. The voltage-current characteristics measuring apparatus 410 is used when a current is measured while a certain value of voltage is applied, or when a voltage is measured while making a certain value of current flow and so on. In the structure of FIG. 16, the voltage-current characteristics measuring apparatus 410 is switched with the switch 400. When the switch 400 is provided on the signal transmission line, frequency characteristics might be changed. The embodiment indicated by the FIGS. 1 and 12 is capable of correcting the frequency characteristics. Namely, the high frequency components of the pulse outputted from the pulse generator 20 pass through the path of the capacitor 91 and the shunt resistor 62 and the path of the capacitor 92. Correction to the frequency characteristics of the signal is carried out with the impedances of the two paths.

Further, the embodiment of FIG. 12 has two shunt resistors and two capacitors for connecting to the shunt resistors in parallel. However, N shunt resistors and N capacitors (N is an integer and greater than 2) can be used for detailed correction of frequency characteristics.

Furthermore, in the above-explained embodiments, the outputs of the probes 40 and 50 are connected to channel one and channel two of the oscilloscope 30 respectively. However, the outputs of the probes 40 and 50 can be inputted to the different oscilloscopes.

Although the present invention has been shown and described with respect to best mode embodiments thereof, it should be understood by those skilled in the art that the foregoing and various other changes, omissions, and additions in the form and detail thereof may be made therein without departing from the scope of the present invention.

1. A device characteristics measuring system that measures the characteristics of a device under test, the system comprising:
a pulse generator that generates pulses,
a first probe for making an electric contact with the device,
a resistor for measuring a current flowing through the device,
a first cable for electronically connecting an output terminal of the first probe with one end of the resistor,
a second cable for electronically connecting an output terminal of the pulse generator with the other end of the resistor,
a second probe for making electrical contacts with both ends of the resistor and for outputting a signal corresponding to a potential difference between the both ends of the resistor, and
a first signal waveform observing unit for observing a waveform of a signal outputted from the second probe.

2. A device characteristics measuring system according to claim 1, further comprising:
a third probe for making an electrical contact with the one end of the resistor, and
a second signal waveform observing unit for observing a waveform of a signal outputted from the third probe.

3. A device characteristics measuring system according to claim 2, wherein the third probe is of an active type and an input impedance of the third probe is higher than an output impedance of the third probe.

4. A device characteristics measuring system according to claim 1, further comprising a capacitor that is connected in parallel to the resistor for improving frequency characteristics.

5. A device characteristics measuring system according to claim 4, wherein the capacitor has capacitance of which value is determined such that a waveform of a current flowing through the device is approximately identical to a waveform observed by the first signal waveform observing unit.

6. A device characteristics measuring system that measures the characteristics of a device under test, the system comprising:
a pulse generator that generates pulses,
a first probe for making an electrical contact with the device,
a series combined resistor including a first resistor and a second resistor that is connected in series to the first resistor,
a first cable for electrically connecting an output terminal of the first probe with one end of the series combined resistor,
a second cable for electrically connecting an output terminal of the pulse generator with the other end of the series combined resistor,
a second probe for making electrical contacts with both ends of the series combined resistor and for outputting a signal corresponding to a potential difference of the both ends of the series combined resistor,
a first signal waveform observing unit for observing a waveform of a signal outputted from the second probe,
a first capacitor connected in parallel to the series combined resistor for improving frequency characteristics, and
a second capacitor electrically connected to the other end of the series combined resistor and a series connection point of the first resistor and the second resistor.

7. A device characteristics measuring system according to claim 6, further comprising:
a third probe for making an electrical contact with the other end of the series combined resistor, and
a second signal waveform observing unit for observing a waveform of a signal outputted from the third probe.

8. A device characteristics measuring system according to claim 7, wherein the third probe is of an active type and an input impedance of the third probe is higher than an output impedance of the third probe.

9. A device characteristics measuring system according to claim 1, wherein the device is made on a semiconductor wafer and the first probe is provided in a semiconductor prober.

10. A device characteristics measuring system according to claim 6, wherein the device is made on a semiconductor wafer and the first probe is provided in a semiconductor prober.

11. A device characteristics measuring system according to claim 1, wherein the second probe is of an active type and an input impedance of the second probe is higher than an output impedance of the second probe.

12. A device characteristics measuring system according to claim 6, wherein the second probe is of an active type and an input impedance of the second probe is higher than an output impedance of the second probe.

13. A device characteristics measuring system according to claim 1, wherein the device includes a phase change memory.

14. A device characteristics measuring system according to claim 6, wherein the device includes a phase change memory.

15. A device characteristics measuring system according to claim 1, wherein the first cable and the second cable are coaxial cables.

16. A device characteristics measuring system according to claim 6, wherein the first cable and the second cable are coaxial cables.
